(19) United States
(12) Patent Application Publication
(10) Pub. No.: US 2007/0142071 A1
(43) Pub. Date: Jun. 21, 2007

(54) Method and apparatus for facilitating establishment of a communication resource

(76) Inventors: Thomas B. Hart, West Dundee, IL (US); Ronald T. Crocker, St. Charles, IL (US); John M. Harris, Chicago, IL (US)

Correspondence Address: MOTOROLA, INC., 1303 EAST ALGONQUIN ROAD, IL01/3RD, SCHAUMBURG, IL, 60196, US

(21) Appl. No.: 11/312,264

(22) Filed: Dec. 20, 2005

(51) Int. Cl. H04B 7/00

(52) U.S. Cl. 455/518

(57) ABSTRACT

A core network element (102) is configured to facilitate establishment of a first type of wireless communication resource, such as a dedicated channel, to facilitate communication with first communication target. The core network element detects a first message using a second type of wireless communication resource, such as a common channel, where the first message is a part of the request for the first communication resource. The core network element also detects within the first message a second message requesting establishment of a first type of wireless communication resource with the at least first communication target. As the result of the first and second messages, the first type of communication resource is established with the at least first communication target, such as a push-to-talk mobile station. The target mobile station will respond with a message indicating that it is either unavailable or not unavailable. If the network control element detects that the target communication unit is unavailable, then it proceeds to break down the establishing of the first type of communication resource. Otherwise, a message is delivered to the originating communication element (114) indicating that the first communication resource is established.

### FIELD OF THE INVENTION

The present invention relates generally to establish a communication resource and, in particular, to establishing a dedicated channel in a wireless communication system

### BACKGROUND

Wireless communications of various kinds and styles are well known in the art. This includes both voice and data services. Wireless communication services based upon telephony-styled service (such as cellular services) are nearly ubiquitous in many countries. Service providers and system consumers of such services are increasingly interested in so-called push-to-talk services. In a typical push-to-talk service offering, a user asserts a push-to-talk button on their communication unit and waits for a particular audible tone. This tone signals that the user can begin speaking to a target recipient. Reducing the latency between asserting the push-to-talk button and the rendering of that audible signal comprises an important design requirement for both system operators and system users.

In a not-untypical deployment, a communication unit responds to assertion of the push-to-talk button by sourcing a short data burst transmission to alert a system push-to-talk server of a push-to-talk request. This transmission will typically include, for example, identifying information for one or more target communication recipients. Following this transmission, the communication unit then automatically begins a series of message exchanges that establish a voice channel. Push-to-talk authorizations (or refusals) are then transmitted to the communication unit via that voice channel.

The above configuration can provide satisfactory service under at least some operating circumstances. In many instances, however, such an approach leaves much to be desired. Presuming availability of the target communication unit, this approach can require at least three seconds between assertion of the push-to-talk button and provision of the speak tone to the user. Such a delay can be objectionably long to many users. This delay can also be frustrating when the system must deny push-to-talk service for whatever reason (such as present unavailability of the target communication unit). Furthermore, establishing a voice channel merely to inform the communication unit that push-to-talk service is presently denied can burden the communication resources of a given system.

In order to reduce the time to notify a user that the target communication unit is available, a core network element is configured and arranged to store communication pathway information for a communication unit that seeks to establish a wireless communication such as a push-to-talk communication using a first type of wireless communication resource to facilitate communications with at least a first communication target. Upon receiving a message from such a communication unit via a second type of wireless communication resource, which message identifies the desired communication target, the network element can store the communication pathway information regarding a present communication location and then determine whether the communication target is likely available for communications. The availability of the communication target can then serve as a basis for providing a kind of preliminary approval to the requesting communication unit. Pursuant to this approach, this preliminary approval can be delivered to the requesting communication unit via the second type of communication resource and also via use of the information regarding the communication location as corresponds to that requesting communication unit.

The requesting communication unit can often be provided with at least a preliminary indication that the target communication unit is available. Based upon that indication, the communication can provide a speak tone to the user prior to actual establishment of the voice channel. This can result in a reduction in delay between assertion of the push-to-talk button and the opportunity to begin speaking as this preliminary assessment regarding likely availability of the communication target and provision of corresponding information regarding such availability using the stored location information can often be effected in only a few milliseconds. Nonetheless, improvements to further reduce the delay of receiving the preliminary indication can be made.

### BRIEF DESCRIPTION OF THE FIFURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

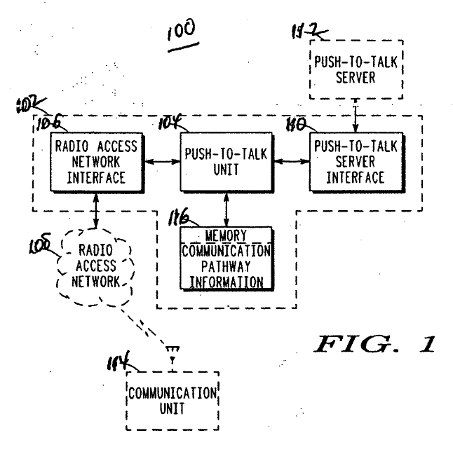

FIG. 1 is an example of a block diagram of a wireless communication system in accordance with some embodiments of the invention.

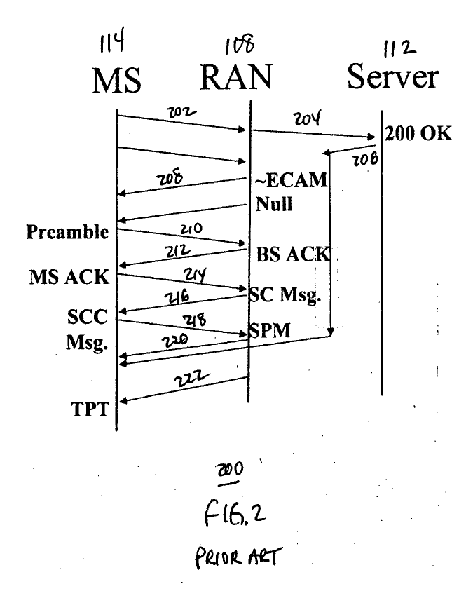

FIG. 2 is a general signal flow timing diagram as configured in the prior art.

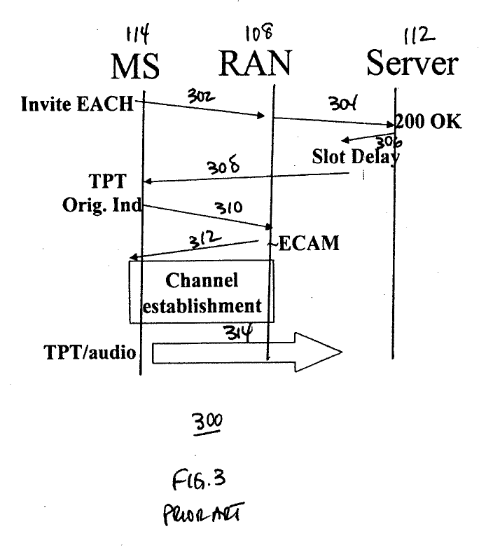

FIG. 3 is a general signal flow timing diagram as configured in the prior art.

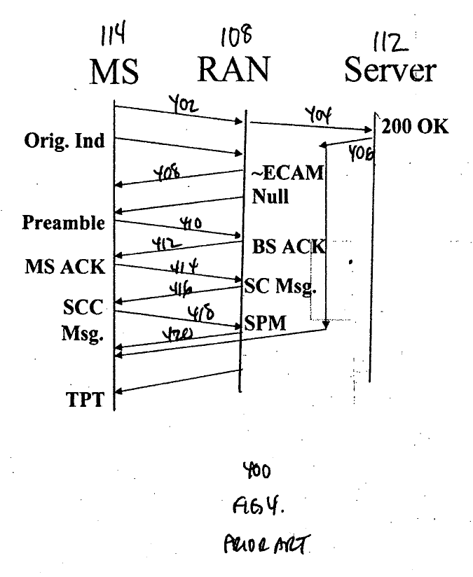

FIG. 4 is a general signal flow timing diagram as configured in the prior art.

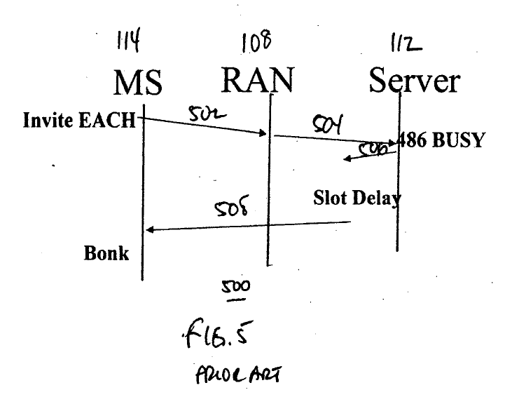

FIG. 5 is a general signal flow timing diagram as configured in the prior art.

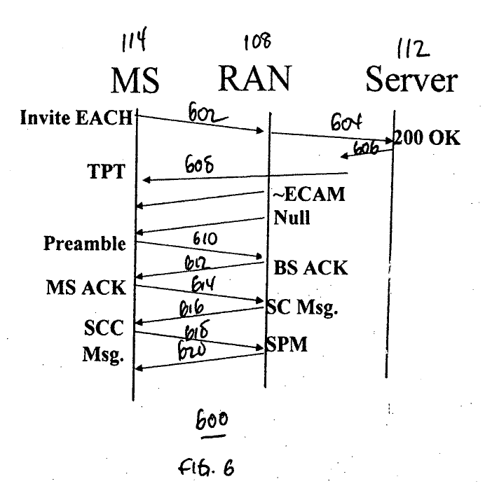

FIG. 6 is a general signal flow timing diagram as configured in accordance with some embodiments of the invention.

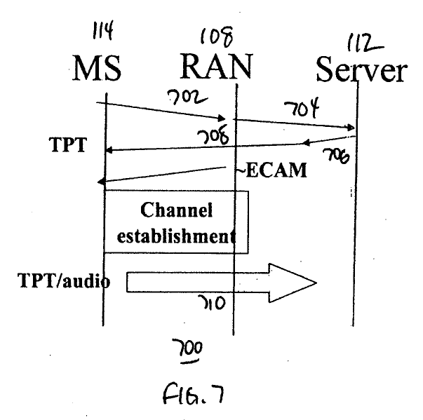

FIG. 7 is a general signal flow timing diagram as configured in accordance with some embodiments of the invention.

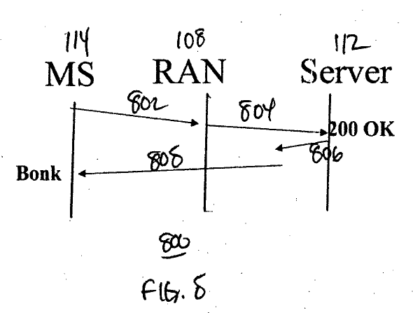

FIG. 8 is a general signal flow timing diagram as configured in accordance with some embodiments of the invention.

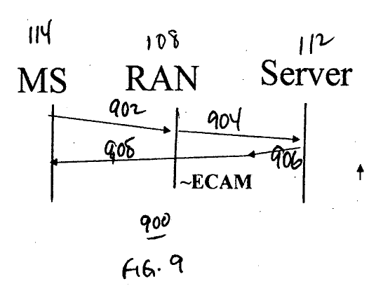

FIG. 9 is a general signal flow timing diagram as configured in accordance with some embodiments of the invention.

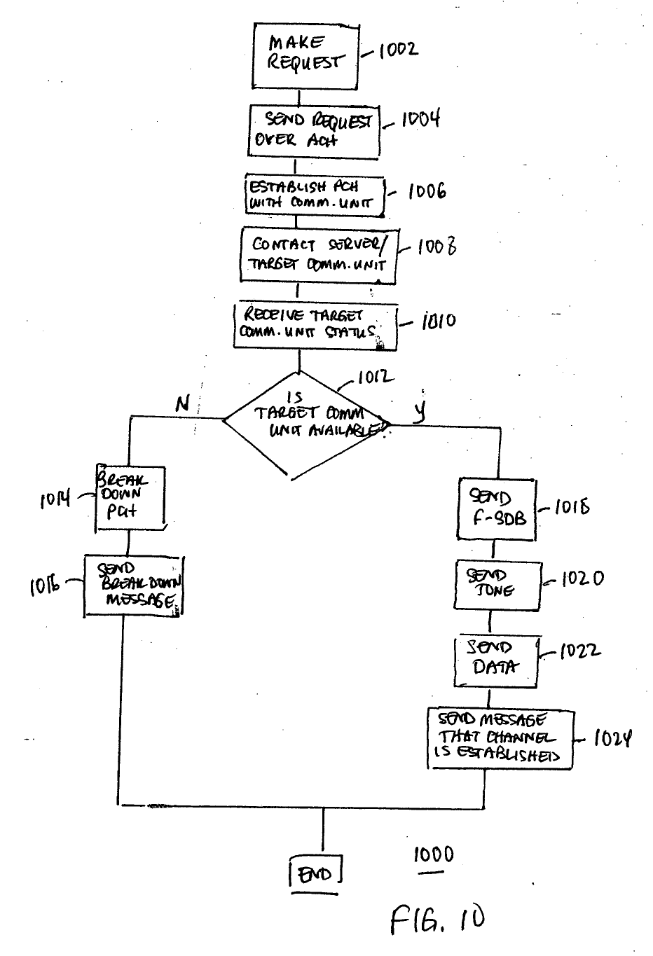

FIG. 10 is a flow diagram as configured in accordance with some embodiments of the present invention.

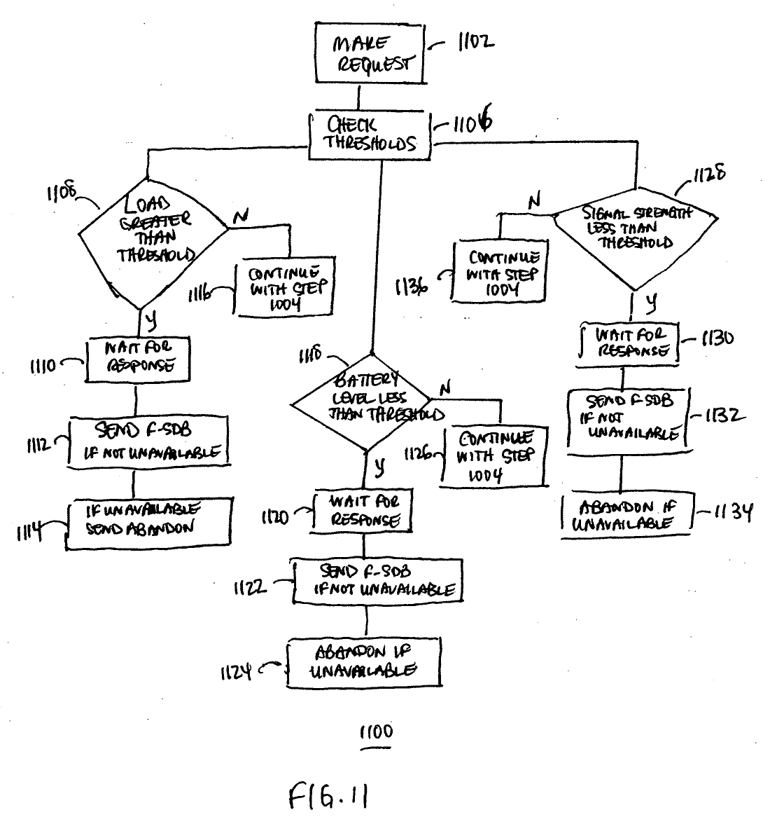

FIG. 11 is a flow diagram as configured in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a method and apparatus for establishment of a communication resource such as a dedicated channel as a part of a wireless communication system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises” “comprising” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of to a method and apparatus for establishment of a communication resource such as a dedicated channel as a part of a wireless communication system described herein. The non-processor circuits may include, but are not limited to, a radio receiver, a radio transmitter, signal drivers, clock circuits, power source circuits, and user input devices. As such, these functions may be interpreted as steps of a method to perform to a method and apparatus for establishment of a communication resource such as a dedicated channel as a part of a wireless communication system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking a core network element is configured and arranged to facilitate establishment of a first type of wireless communication resource, such as a dedicated channel, to facilitate communication from a communication originator with first communication target. The core network element detects a first message from the communication originator using a second type of wireless communication resource, such as a common channel, where the first message is a part of the request for the first communication resource. The core network element also detects within the first message a second message requesting establishment of a first type of wireless communication resource with the at least first communication target. The second message can be a special extended burst type message or its equivalent in a reconnect message from the communication originator or session initiation protocol invite message. The second message can also be a packet control function message when the radio access network element detects a packet arriving.

As the result of the first and second messages, the first type of communication resource is established with the at least first communication target unit, such as a push-to-talk mobile station. The target communication unit will respond with a message indicating that it is either unavailable or not unavailable, e.g. that it is trying to make the connection or that it is available. If the network control element detects that the target communication unit is unavailable then it proceeds to break down the establishing first type of communication resource at the communication originator. On the other hand, if the core network element detects that the target is not unavailable, a message is delivered to the originating communication element, such as another push-to-talk mobile station, indicating that the first communication resource is established while the first type of communication resource is still being established. The core network element can also establish threshold period in which to receive the message that the at least first communication target is unavailable and the second indication that the at least a first communication target is not unavailable. In addition, the core network element can delay establishment of the first type of communication resource at the communication originator until at least a packet for the communication originator is received or a threshold amount of time has elapsed. With the threshold, the first communication resource will be established with at least a first communication target after a first threshold has expired. The threshold can be to detect loading, signal strength or battery life. The core network element may also delay establishing the first type of communication resource when detecting a trigger after detecting within the first message a second message requesting establishment of a first type of wireless communication resource with the at least first communication target.

Referring now to the drawings, and in particular to FIG. 1, there is shown a wireless communication network 100 any of a wide variety of core network elements 102, alone or in combination with one another. Wireless communication network 100 can be any of the variety of wireless networks known including a code division multiple access network (CDMA), CDMA 2000, universal mobile telecommunication system (UMTS), push-to-talk (PTT) dispatch network, push-to-talk over Cellular (PoC) network. Core network element 102 can serve as an enabling platform to affect one or more of the teachings set forth herein. For example, a core network element 102 can comprise a packet control function, a packet data services node, or the like, alone or in combination with one another. It will therefore be understood that, although the singular “core network element” will often be used herein for purposes of explanation, the expressions “core network element” and “network element” are also to be read to include a plurality and/or combination of such elements.

In an embodiment for a PTT or PoC network, the network element 102 will ordinarily feature in accord with prior art practice. Pursuant to these embodiments, the core network element 102 will further comprise a push-to-talk unit 104 that operably couples via a radio access network interface 106 to a radio access network 108, the latter being well known and understood in the art. In a similar fashion, the push-to-talk unit 106 can also couple via a push-to-talk server interface 110 to a push-to-talk server 112 as is also well known and understood in the art.

So configured, the push-to-talk unit 104 serves to facilitate the communication needs of a wireless communication unit 114 and in particular the push-to-talk communication needs of such a user. In an embodiment the radio access network will support at least two types of differing communication resources. One such communication resource can comprise, for example, a shared paging communication resource that will support, for example, short data bursts (SDB) and packet control function (PCF). Such short data bursts can serve well to transmit initial communication requests, identification information regarding a target communication unit, messages reflecting the likely availability of the target communication unit, and the like. The other communication resource can comprise, for example, a dedicated communication channel useful, when allocated, to support a voice communication between the communication unit and the target communication unit.

FIG. 2 illustrates a call signal flow timing diagram of the prior art and is described here in, together with FIGS. 3-6, to aid in the understanding of the present invention, described below. The call signal flow diagrams shown in the FIGS. 2-6 show the different messages and signals that are sent between the communication unit 114, the RAN 108, including core network element 102, and the server 112. FIG. 2 is an illustration of the prior art 200 when it is determined by the core network element 102 that the target communication unit is not busy and will accept the call. To begin, the communication unit 114 sends 202 an invite message over the access channel to each of the target communication units that are to be a part of the call. For PTT and PoC calls and other wireless communication technologies, there may be more than one target communication unit, while in other prior art technologies the originating communication unit 114 can communicate with one target. The RAN 108 forwards 204 the message to the server 112, which responds 206 with an OK message, and in particular a 200 OK message. The RAN 108, with the core network element 102, sends 208 a message, which can be an ECAM message, to establish the paging channel with the mobile station 114. The process continues with a series of messages between the communication unit 114 and the RAN 108 that can take up to 4000 msecs to complete. These messages include sending 210 a preamble from the communication unit 114 to the RAN 108. The RAN 108 responds 212 with an acknowledgement message and the communication unit 114 responds 214 to with its own acknowledgement message. The RAN then sends 216 a service control (SC) message to the communication unit, which responds 218 with a service control complete (SCC) message. The RAN sends 220 an SPM message to complete the paging channel set up process. With the process complete, the communication unit 114 sends talk permit tone (TPT) data to the RAN 112 and the server 112. TPT is an indication to the originator that the target is available, and thus the originator can begin communication with the knowledge that the target will actually receive the communications from the originator.

FIG. 3 illustrates an alternative version 300 of the prior art when the target communication unit is not busy. In this embodiment, the concept of glare is introduced into the process of establishing the paging channel. Glare is understood by those of skill in the art as the situation where the originating communication unit 114 is tying to place itself on the traffic channel at the same time while the server 112 is trying to send the communication unit a response from the target about its availability. This can result in a race condition between the communication unit 114, the RAN 108, including the core network unit 102, and the server 112 while the units are trying to establish a dedicated paging channel at the same time and unbeknownst to the other. This can result in somewhat redundant and unnecessary messaging between the communication unit 114 and the RAN 108.

In a glare situation, the communication unit 114 sends 302 an invite message to the RAN 108, which is then forwarded 304 onto the server 112. After receiving invite message, the server 112 indicates 306 to the RAN 108 that the target communication unit or units are not busy. In being not busy, the server can be informing the RAN that the target communication unit is available or that it is still trying to connect to the target. In other words the server 112 can be informing the RAN that the target communication unit is not unavailable. A slot delay typically occurs at both the originator and the target. The slot delay is the time during which the communication device is sleeping, thereby conserving battery life, and thus not monitoring for incoming messages. The purpose of the slot delay is to improve battery life. The slot delay is sent 308 from the server 112 through the RAN 108 to the communication unit 114. The communication unit 114 sends 310 a TPT or more typically a 100 trying message to the RAN 108. An ECAM message is sent 312 from the RAN 108 back to the communication unit 114 which gives the address of the target and establishes the paging channel between RAN 108 and the communication unit 114 such that TPT audio data can be exchanged 314.

FIGS. 4 and 5 demonstrate the flow of messages between the communication unit 114 and the server 112 when the target communication unit is determined by the server 112 to be busy or unavailable. Similar to what is described in relation to FIG. 2, FIG. 4 is an example of the prior art 400 without glare whereby the network is establishing the paging channel even though it is determined that the channel is unnecessary because the target is busy. To begin, the communication unit 114 sends 402 an invite message over the access channel to each of the target communication units that are to be a part of the call. The RAN 108 forwards 404 the message to the server 112, which responds 406 with an OK message, and in particular a 200 OK message. The server 112 may immediately respond to receiving an invite message by responding to the communication unit 114 with a 100 trying message. In some systems, the communication unit 114 will generate a talk permit tone or beep based on receiving the 100 trying message. In other systems, the communication unit 114 will wait until it receives a 200 OK message before playing the talk permit tone. The 200 OK message is typically generated by the target communication unit or only after the target communication unit has be located. In an attempt to minimize the delay perceived by the communication unit 114, however, the talk permit tone is often played solely based on the response from the server 112, e.g., when the communication unit 114 receives a 100 trying message. Additionally, there are cases where the server 112 may know that the target communication unit is already on traffic channel and therefore the server 112 can generate the 200 OK messages on the target communication unit's behalf.

The RAN 108, with the core network element 102, sends 408 a message, which can be an ECAM message, to establish the paging channel with the mobile station 114. The process continues with sending 410 a preamble from the communication unit 114 to the RAN 112. The RAN 112 responds 412 with an acknowledgement message that the communication unit 114 responds 414 to with its own acknowledgement message. The RAN then sends 416 a SC message to the communication unit, which responds 418 with an SCC message. The RAN sends 420 an SPM message to complete the paging channel set up process. As the target is not available, the channel is tom down 422 with a message sent from the communication unit 114 to the server 112.

FIG. 5 is an example of the prior art 500 similar to that shown in FIG. 3 when glare is utilized but when the target is determined to be busy. In this embodiment, the communication unit 114 sends 502 an invite message to the RAN 108, which is then forwarded 504 onto the server 112. After receiving invite message, the server 112 indicates 506 to the RAN 108 that the target communication unit or units are busy with a busy message or in particular a 486 Busy message. A slot delay is inserted into the process so that the RAN can determine the exact message received from the server. The slot delay is sent 508 from the server 112 through the RAN 108 to the communication unit 114. The communication unit 114 sends 510 a message to the RAN 108. The delay can be of a varied amount of time and can be in the range of 600 msecs. This delays the notification to the communication unit 114 that the paging channel should not be established even though the communication unit may be in the process of trying to establish the channel.

Turning to FIG. 6, a signal flow diagram 600 of the present invention is shown that avoids separate origination and slot delay without sacrificing glare benefits. The process begins with the communication unit 114 sending 602 and invite message to the RAN 108. As with earlier descriptions, the RAN 108 sends 604 the invite message to the server 112 to determine if the target communication unit is available. In this embodiment, the target communication unit is determined to be not unavailable such that it is either available or the server is still trying to reach the target. In response to the OK message, the server and the RAN immediately notify 606 the communication unit that the target is available. In addition, the RAN 108 sends 608 the address of the target in an ECAM message. The process continues with the communication unit sending 610 a preamble to the RAN. The RAN 112 responds 612 with an acknowledgment to the communication unit 114, which also sends 614 its own acknowledgment back to the RAN. As stated in connection with FIG. 2, the RAN sends 616 a SC message to the communication unit that returns 616 a SCC message. The RAN can then send 618 the SP message. At this point, the RAN 108 and the communication unit 114 have already started the process of setting up the paging channel and the communication session can proceed. In this embodiment of the present invention, a time savings of approximately 4000 msecs can be observed by the exchange of the TPT message upon the receipt at the RAN that the target communication unit is available instead of waiting for the SPM message to be received by the communication unit 114.

FIG. 7 illustrates an embodiment 700 of the present invention that avoids separate origination and slot delays while obtaining the benefits of glare when the target is busy. The process begins when the communication unit 114 sends 702 an invite message to the RAN, which, in turn, forwards 704 the message to the server 112. The server 112 determines that the target communication unit is available and sends 706 an OK message, or a 200 OK message, to the RAN. As the glare is set and the RAN is informed that the target is available, the RAN sends a TPT message to the communication unit 114 and the ECAM address of the target. Thereafter, the channel establishment continues 708 between the communication unit 114 and the RAN 108, including the core network unit 102 and the server 112. In this embodiment there can be seen a saving of approximately 600 msecs in the time it takes to set up the channel because the present invention avoids the slot delay that was inserted into the prior art.

FIGS. 8 and 9 are embodiments 800, 900 of the present invention when it is determined that the target communication unit is unavailable. In FIG. 8, the communication unit 114 sends 802 the invite message to the RAN 108 that forwards 804 the invite message to the server 118. The server sends 806 a message indicating that the target is unavailable and the channel is not setup. Accordingly, there are RF and battery benefits. This process eliminates unnecessary traffic channel establishment and reduces switching, RF, channel elements, Walsh code capacity impacts. As with FIG. 6, this embodiment can save up to 4000 msecs of time notifying the system elements that no paging channel needs to be established.

FIG. 9 shows a glare environment where the target is unavailable. The communication unit 114 sends 902 the RAN 108 an invite message for a target communication unit. The RAN 108 forwards 904 the invite message to the server 112 which determines that the target communication unit is unavailable. Without delay, a busy message is sent 406 to the RAN from the server and the MS is then informed 908 with the paging channel will not be used.

Turning to FIG. 10, a flow chart of the process 1000 improving the establishment of a dedicated paging channel the reducing the likelihood that a mobile communication unit 114 and the RAN 108 are establishing the traffic channel unnecessarily. The process begins with the communication unit making a request 1002 to establish a communication channel with at least one target communication unit. The request is sent 1004 over the access channel between the communication unit 114 and the RAN 108. The request includes a header indicating that a request for at least one target communication unit is being made. In addition to the header, the message includes a payload that initiates the establishment of a paging channel between the RAN 108 and the communication unit 114. Upon receipt of the message, the RAN begins to establish 1006 the paging channel with the communication unit. In addition, the RAN 108 forwards 1008 the message onto the server to determine if the target communication unit is available. In response to the request from the server, the RAN will be informed 1010 about the availability of the target communication device.

Upon receipt of the target communication unit's status, the RAN and the communication unit interpret 1012 the status to determine what to do with setting up the paging channel. If it is determined that the target communication unit is unavailable, the RAN 108 and the communication unit 114 begin to break down 114 the paging channel that was being established between the two at step 1006. A message is also sent 1016 from the RAN to the communication unit 114 that the target communication is unavailable upon receipt of the message from the server 112.

If it is determined that the target is not unavailable, such that the server is still trying to contact that target or is informed that the target is available, the RAN 108 sends a forward short data burst (F-SDB) to the communication unit 114 updating the target is available. Upon receipt of the F-SDB message, the communication unit indicates 1020, e.g. sends an audible tone to the user, that the channel is established. The communication unit 114 may then be used by a user for sending the data to the target. It is understood by one of skill in the art, however, that the paging channel may still be in the process of being established between the communication unit and the RAN. Accordingly, data that is provided by the user to the communication unit is buffered 1022 until the paging channel is completed. In an alternative embodiment, the RAN updates 1024 the communication unit 114 with a message that the paging channel has been established while the communication unit and the RAN are still establishing the paging channel. Thus, the communication unit can accept data to be sent to the target, which may be stored in a buffer until the paging channel is completed. In addition, a channel assignment message is sent 1026.

Turning to FIG. 11, another embodiment of the present invention is shown where a threshold value is inserted in the processes described above. As will be understood by those of skill in the art, glare can increase the requirements on communication network resources such as the core network element 102, RAN 108 and server 112. In order to reduce these requirements, at least one threshold value to serve as a gating function for paging channel establishment may be used. Similar to FIG. 10, the process of the present invention that includes thresholds starts 1102 with a communication unit 114 requesting communication with a target communication unit and the process continues to when the RAN 108 receives 1102 a message from the communication unit 114 requesting the paging channel. Upon receipt, the RAN 108 checks 1106 thresholds to determine how to proceed in establishing the paging channel between the RAN 108 and the communication unit if it was determined that the target communication is not unavailable.

One of a number of different thresholds can be set and checked. In one embodiment, a load threshold is set by the RAN 108. The load threshold is set to a level of load on the network resources, including the core network element 102, RAN 108 and server 112, within the wireless communication network to which network will operate optimally. If the load is great, a delay in the channel assignment may benefit the system as to increase the probability of a complete channel assignment. In other words, if a network load is greater than a threshold, it may not be desirable to assign a paging channel unit the RAN 108 receives an acknowledgment from the server 112. If the load is less than a threshold, the RAN 108 can immediately assign the paging channel without waiting. Accordingly, upon receipt of the message that that target communication unit is not unavailable, it is determined 1108 whether the network load is greater than the load threshold. If the load is greater than the threshold, then the RAN waits 1110 a set amount of time for a response packet to be received from the target communication unit. If the response packet contains a message that the target communication unit is not unavailable, the RAN 108 sends 1112 a F-SDB paging channel containing packet immediately followed by the channel assign message. If the response packet contains a message that the target communication unit is unavailable, the RAN 108 does not send an ECAM message, but abandons 1114 the call attempt and sends a release. This message can be sent over the common channel delivering the busy message. If the load is less than the threshold, the RAN continues 1116 as described above in connection with FIG. 10.

In another embodiment, a battery threshold is set by the RAN 108. The battery threshold is set to level of battery resources available for the communication unit. If the battery resources are low, a delay in the channel assignment may benefit the system as to increase the probability of a complete paging channel assignment. In other words, if battery resources are less than a threshold, it may not be desirable to assign a paging channel unit the RAN 108 receives an acknowledgment from the server 112. If the battery resources are greater than a threshold, the RAN 108 can immediately assign the paging channel without waiting. Accordingly, upon receipt of the message that that target communication unit is not unavailable, it is determined 1118 whether the battery resources of the communication unit 114 is less than the battery threshold. If the resources are less than the threshold, then the RAN waits 1120 a set amount of time for a response packet to be received from the target communication unit. If the response packet contains a message that the target communication unit is not unavailable, the RAN 108 sends 1122 a F-SDB paging channel containing packet immediately followed by the channel assign message. If the response packet contains a message that the target communication unit is unavailable, the RAN 108 does not send an ECAM message, but abandons 1124 the call attempt and sends a release. This message can be sent over the common channel delivering the busy message. If the battery resources are greater than the threshold, the RAN continues 1126 as described above in connection with FIG. 10.

In yet another embodiment of the present invention, a signal strength threshold is set by the RAN 108. The signal strength threshold is set to level of signal strength between the RAN 108 and the communication unit 114. If the signal strength is weak, a delay in the channel assignment may benefit the system as to increase the probability of a complete channel assignment. In other words, if signal strength is less than a threshold, it may not be desirable to assign a paging channel unit the RAN 108 receives an acknowledgment from the server 112. If the signal strength is greater than a threshold, the RAN 108 can immediately assign the paging channel without waiting. Accordingly, upon receipt of the message that that target communication unit is not unavailable, it is determined 1128 whether the signal strength between the RAN 108 of the communication unit 114 is less than the signal strength threshold. If the signal strength is less than the threshold, then the RAN waits 1130 a set amount of time for a response packet to be received from the target communication unit. If the response packet contains a message that the target communication unit is not unavailable, the RAN 108 sends 1132 a F-SDB paging channel containing packet immediately followed by the channel assign message. If the response packet contains a message that the target communication unit is unavailable, the RAN 108 does not send an ECAM message, but abandons 1134 the call attempt and sends a release. This message can be sent over the common channel delivering the busy message. If the signal strength is greater than the threshold, the RAN continues 1136 as described above in connection with FIG. 10.

As will be understood by those of skill in the art, the inventive process described above can provide time benefits in establishing a paging channel between the communication unit 114 and the RAN 108. As compared to previously known non-glare operations of paging channel establishment, the time benefit can be between 3 and 4 seconds because the described process avoids approximately 25% of the channel establishment process before the communication unit receives notification that the channel is established. This can also provide benefits to RF, battery and paging and access channel establishment. As compare to previously known glare operations, the time benefit can be approximately 600 msecs. These benefits apply to when the target is either unavailable or not unavailable.

With the addition of a load threshold, the present invention reduces the paging channel load. It also improves presence check reliability. These improvements are achieved by reducing the time between a reverse SDB message and the forward SDB message. Accordingly, there is a reduction in the issues related to user mobility between the sending of the SDB messages.

In implementation of the present invention, when the RAN 108 receives a reverse SDB from a communication unit 114 over an access channel, the RAN 108 sends an indicator to indicate an ECAM message. Instead of an ECAM message, the RAN can wait and immediately assign a paging channel. This will not necessarily delay channel assignment for other reconnect application because the message should occur quickly and in parallel with resource allocation. Alternatively, the RAN can wait up to a given amount of time for an affirmative response from the server 112 and the target communication unit. After the threshold expires then the RAN should assign an channel if no response has been received.

When the RAN 108 receives a response from the server, it can convey the channel assignment authorization or deauthorization to the communication unit 113. When the RAN 108 receives an indication to send a packet, it will implicitly understand that the packet to be followed with a channel assignment.

In another embodiment, the originating communication unit 114 may be in a situation where it is less likely to fail traffic cannel assignment such as when the communication unit 114 is an area of good coverage. In this situation, the method and apparatus of the present invention described herein are helpful because the system delays channel assignment. The originating communication unit 114 may slightly increase the probability that it establishes a dedicated channel because the process of establishing the channel is somewhat expanded. As will be understood, the process is expanded based on the possible delays in the process.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method to facilitate establishment of a first type of wireless communication resource to facilitate communication from an communication originator with at least a first communication target comprising:
detecting a first message from the communication originator using a second type of wireless communication resource;
detecting within the first message a second message requesting establishment of a first type of wireless communication resource with the at least first communication target;
establishing the first type of communication resource with the at least first communication target;
performing at least one of the following:
delaying establishment of the first type of communication resource at the communication originator until at least a packet for the communication originator is received or a threshold amount of time has elapsed;
breaking down the establishing of the first type of communication resource at the communication originator upon receipt of a first indication that the at least a first communication target is unavailable,
delivering a third message indicating that at least first communication target is available while establishing the first type of wireless communication resource at the communication originator, and
establishing the first type of communication resource at the communication originator upon receipt of a second indication that the at least a first communication target is not unavailable.

2. The method of claim 1 further comprising establishing a first threshold period in which to receive the first indication that the at least a first communication target is unavailable and the second indication that the at least a first communication target is not unavailable.

3. The method of claim 2 wherein establishing a first communication resource with the communication originator after a first threshold has expired.

4. The method of claim 2 wherein establishing a first communication resource with the communication originator after a first threshold period has expired being at least one of a loading is greater than a loading threshold, a signal strength is less than a signal threshold and a battery life threshold is less than a battery life threshold.

5. The method of claim 1 wherein when a loading is greater than a loading threshold comprising assigning a first resource after receiving the indication that the at least a first communication target is not unavailable.

6. The method of claim 1 wherein the first communication resource is a dedicated channel.

7. The method of claim 1 wherein the second communication resource is a common channel.

8. The method of claim 1 wherein the breaking down further comprising delivering a busy notification to an originating communication device.

9. The method of claim 9 wherein the busy notification being delivered over the second communication resource.

10. The method of claim 1 wherein delaying the establishment of the first type of communication resource at the communication originator also includes delaying the establishment of the first type of communication resource at the communication originator if a loading is greater than a loading threshold, a signal strength is less than a signal strength threshold, a battery life is less than a battery life threshold and the communication originator is less likely to fail traffic channel assignment.

11. A core network element comprising:
a radio access network interface;
a processor coupled to the radio access network interface wherein the processor is configured to receive a request from a communication originator for a first communication resource with at least a first communication target that is received by the radio access network interface on a second communication resource and to begin establishing the first communication resource and wherein the processor further configured to perform at least one of the following delay establishment of the first type of communication resource at the communication originator until at least a packet for the communication originator is received or a threshold amount of time has elapsed, break down the establishment of first communication resource at the communication originator upon receipt of a first message that the at least a first communication target is unavailable, send a second message that the at least first communication target is available while establishing the first type of wireless communication resource at communication indicator, establish the first type of communication resource at the communication originator upon receipt of a third message that the at least a first communication target is not unavailable.

12. The core network element of claim 11 wherein the processor being configured having a first threshold period in which to receive the second message that the at least a first communication target is unavailable and the third message that the at least a first communication target is not unavailable.

13. The core network element of claim 12 wherein the processor being configured to further establish a first communication resource with at least a first communication target after a first threshold has expired.

14. The core network element of claim 12 wherein the processor being configured to establish the first communication resource with at least a first communication target after a first threshold period has expired being at least one of a loading is greater than a loading threshold, a signal strength is less than a signal threshold and a battery life threshold is less than a battery life threshold.

15. The core network element of claim 11 wherein the processor is configured to detect a loading that is greater than a loading threshold comprising assigning a first resource after receiving the indication that the at least a first communication target is not unavailable.

16. The core network element of claim 11 wherein the first communication resource is a dedicated channel.

17. The core network element of claim 11 wherein the second communication resource is a common channel.

18. The core network element of claim 11 wherein the processor breaking down the first communication resource further comprising delivering a busy notification to an originating communication device.

19. The core network element of claim 18 wherein the processor delivering the busy notification being delivered over the second communication resource.

20. The core network element of claim 11 wherein the processor establishing the first type of communication resource being delayed also if at least one a loading is greater than a loading threshold, a signal strength is less than a signal strength threshold, a battery life is less than a battery life threshold and the communication originator is less likely to fail traffic channel assignment.
